(19) United States
(12) Patent Application Publication
(10) Pub. No.: US 2020/0234318 A1
(43) Pub. Date: Jul. 23, 2020

(54) SOCIAL SCIENCE MACHINE FOR MEASURING LATENT VARIABLE MODELS WITH BIG DATA SURVEYS

(71) Applicant: SEER ANALYTICS, LLC, Tampa, FL (US)

(72) Inventors: William W. Lazarus, Tampa, FL (US); Nathan G. Valentin, Temple Terrace, FL (US)

(21) Appl. No.: 16/823,504

(22) Filed: Mar. 19, 2020

Related U.S. Application Data
(63) Continuation of application No. 15/491,958, filed on Apr. 19, 2017.
(60) Provisional application No. 62/325,449, filed on Apr. 20, 2016.

(51) Int. Cl. G06Q 30/02

(52) U.S. Cl. CPC G06Q 30/0203

(57) ABSTRACT

The current invention is a Social Science Machine designed to articulate social science theory-based latent variable models, to operationalize such models through survey research methodologies, and to obtain valid comparative measurements of such latent variable models from such methodologies. The embodiment described herein is the performance measurement of Well-Being Programs which are programs designed to improve the physical, or psychological health, social connectivity, coping capabilities, and development of their participants. Measurement of Well-Being Programs is fraught with threats to validity from Selection and Response Biases. The invention explicitly deals with Selection and Response Biases and can be used to establish a virtuous cycle of feedback to drive performance improvements in human services analogous to what has been achieved in manufacturing with Statistical Process Control. The invention employs a collaborative, multi-entity approach for the standardized collection and analysis of Big Survey Data derived from multiple organizations.

### CROSS REFERENCE TO RELATED APPLICATIONS

This application claims priority under 35 U.S.C. § 119(e) to pending U.S. patent application U.S. Ser. No. 15/491,958, filed Apr. 19, 2017, entitled A SOCIAL SCIENCE MACHINE FOR MEASURING LATENT VARIABLE MODELS WITH BIG DATA SURVEYS, U.S. Provisional Patent Application expired, No. 62/325,449, filed Apr. 20, 2016, entitled “PLATFORM FOR ADMINISTRATION, ANALYSIS AND REPORTING OF IDENTIFIED SURVEYS”, which are hereby incorporated by reference in their entirety.

### BACKGROUND OF THE INVENTION

### 1. Field of the Invention

The present invention relates to software for creating surveys and analyzing survey data. More specifically, it relates to software for specifying and measuring latent variables as a basis for analyzing large survey data sets.

### 2. Description of the Related Art

Governmental, educational, non-profit, and corporate entities invest billions of dollars annually on non-clinical interventions and programs designed to enhance youth development, and improve the health, productivity and well-being of their employees and constituents. For the sake of clarity and consistency, all such programs intentionally designed, in some way, to improve or advance the physical, or psychological health, social connectivity, coping capabilities and development of their participants, are referred to as Well-Being Programs. Not surprisingly, entities committing significant funding and effort to their Well-Being Programs have a genuine desire to measure the effectiveness and impact of them. These entities wish to identify those Well-Being Programs that work and continually improve such programs. At the same time, they wish to identify programs that may be less impactful and effective with a goal of either improving or discontinuing them. One of the most effective ways to measure impact is through national comparative and normative metrics. Knowing that 36% of respondents to an evaluation survey rate your program as “Excellent” on some important attribute, doesn't really tell you much. On the other hand, if you know both your local score and the National Average % “Excellent” for that attribute, across multiple similar programs being offered around the country, then you know a great deal more. If your program is 36% “Excellent,” and the National Average is 18% “Excellent,” then you know something. Likewise, if you were to learn that the National Average % “Excellent” for that attribute was 72%, you would know something else. And if you were to know that the overall National Average was 36% “Excellent,” but that among the particular demographic segment, your Well-Being Program serving the National Average is 20%, then you know even more.

Entities that sponsor or fund Well-Being Programs (including foundations, grant-making governmental authorities, corporations, school districts, etc.), as well as the entities that offer the programs (such as youth-serving non-profits, schools, and corporations offering in-house employee wellness programs, and for-profit corporations offering Well-Being Programs to third parties), want to have a firm understanding of the impact of their programs; an understanding that is based on peer-reviewed social science research, and large volumes of reliable, valid, and commensurable impact evaluation data. Normative and comparative benchmarks, like % “Excellent” on some important attributes are extremely rare. In order to develop such benchmarks, requires the coordination of multiple Well-Being Program providers on a national basis, using consistent questionnaires based on explicit social science theory. There are very few examples of such coordinated, intentionally comparative, research efforts. Standardized processes and software for mapping Well-Being Program survey results back to their underlying social science concepts, and for generating commensurable performance metrics across like programs, do not exist.

It is possible in some instances to adduce reliable and valid Well-Being Program evaluative metrics from arms-length, 3^{rd} party sources. For example, a youth development Well-Being Program might look at school district truancy data as an index of program effectiveness. However, this approach to generating evaluative data is the rare exception. One might imagine that a Healthy Eating program targeting borderline-obese adults could look at weight loss as a metric of impact. However, the scientific literature is clear: short-term weight loss is a very poor predictor of the kinds of long-term behavioral/life-style changes that have been shown to prevent the onset of type 2 diabetes in at-risk populations. A much better metric of that Well-Being Program's impact—one supported by a vast corpus of empirical social science research—is the change in a participant's sense of “Self-Efficacy,” resulting from participating in the program. The only way to determine a change in self-efficacy or any other subjective experience is to ask.

Well-being is multidimensional with physical, psychological, social and other aspects, all of which are subjectively experienced. The way social scientists tend to measure subjective experience is by asking formal scripted, scaled questions, i.e., through survey research. Survey research that measures people's perceptions, attitudes, beliefs, intentions and feelings, has been at the core of quantitative social science since the dawn of quantitative social science in the first half of the 20th Century. Unfortunately, the current art of survey research is woefully flawed for the measurement of Well-Being Programs. Specifically, the current art cannot adequately address core requirements stated above “to identify those Well-Being Programs that work and continually improve such programs . . . and to identify programs that may be less impactful and effective with a goal of either improving or discontinuing them.” The reasons for this deep inadequacy are many. They include lack of consistency and commensurability of metrics, inappropriate unit and level of analysis, lack of a clear theoretical foundation and conceptual framework, imprecise (or absent) specification and operationalization of latent variables, and, imprecise (or absent) mapping of latent variables to questionnaire items. A system that addresses consistency and commensurability of metrics, that measures a useful unit of analysis, that clearly exposes its theoretical foundation and conceptual framework, that specifies its latent variable models and explicitly maps questionnaire items to those models, would be a major addition to the current art. In addition, the current art for measuring Well-Being Programs is beset with a host of fallacies and measurement errors that result from two core threats to the validity of the current art: Selection Bias, which confounds multiple effects, attributing the impact of all of these effects to the program, and Response Bias, which assumes that the distribution of non-responder attitudes closely mirrors that of responders', an assumption that is patently false in the case of Well-Being Program impact evaluation surveys. The combined effects of Selection Bias and Response Bias lead to the gross overestimation of program impacts and have caused large sectors of the academic and business community to discount the value of both Well-Being Programs and evaluations of such programs.

It would be desirable to have surveys, that provide the entities offering Well-Being Programs and the entities sponsoring such surveys, with commensurable, trackable, and richly diagnostic reports based on social science research. To do so, requires an approach that addresses Selection and Response Bias. Such an approach must be comparative and grounded in large, robust data sets designed to facilitate comparative reporting. The assembly of such data sets is beyond the capacity of any single provider of Well-Being Programs. The invention described herein facilitates a collaborative approach to measurement, analytics, and reporting, organized and coordinated through credible national Sponsoring Organizations, that will provide entities offering Well-Being Programs, the insights and tools to increase their impact over time.

### SUMMARY OF THE INVENTION

The current invention is a Social Science Machine designed to articulate social science theory-based latent variable models, to operationalize such models through survey research methodologies, and to obtain valid comparative measurements of such latent variable models from such methodologies. The embodiment described herein is the performance measurement of Well-Being Programs which are programs designed to improve the physical, or psychological health, social connectivity, coping capabilities, and development of their participants. Measurement of Well-Being Programs is fraught with threats to validity from Selection and Response Biases. The invention explicitly deals with Selection and Response Biases and can be used to establish a virtuous cycle of feedback to drive performance improvements in human services, analogous to what has been achieved in manufacturing with Statistical Process Control. The invention employs a collaborative, multi-entity approach for the standardized collection and analysis of Big Survey Data derived from multiple organizations.

The invention described herein provides multiple users (academics and practitioners) with rigorous, explicit mappings of theory to measure, to Questionnaire Item, to dimension etc. to generate massive volumes of data that can be analyzed with Big Data tools. The innovative organizational structure proposed herein, with the Sponsoring Organization connecting multiple Participating Entities into learning networks delivering commensurable measures, and vast nation data sets might enable the Participating Entities to conduct social science at scale building fully commensurable metrics and cumulative learning in a remarkably cost-effective manner. The tools of this invention's implementation include software (data bases, APIs, UIs), and configuration tools for questionnaire set-up, calculation set up, and other features, to facilitate the conduct of social science research among and across different types of Participating Entities.

In one aspect of the present invention, a method of creating a survey instrument by a Sponsoring Organization for evaluating a Well-Being Program conducted by a Participating Entity is described. The Sponsoring Organization creates a conceptual framework which includes a statement of a social-science based theory underlying the framework and a latent variable model. Latent variables in the model are mapped or connected to one or more operational measures. The operational measures are then mapped to multiple questionnaire items. The Sponsoring Organization finalizes the survey instrument by ordering the questionnaire items, determining the scale of said items, creating respondent instructions and other tasks. The Sponsoring Organization can then determine performance metrics for each Participating Entity that is administering the survey to it program participants.

In another aspect of the present invention, a Participating Entity administers a survey to its program participants to evaluate a Well-Being Program. The Participating Entity subscribes to a survey created and provided by a Sponsoring Organization in order to evaluate and improve its Well-Being Program. The entity specifies one or more goals in relation to a conceptual framework embodied in the survey. It also identifies one or more questions in the survey which are of particular importance or significance to the Well-Being Program administered by the Participating Entity.

In one embodiment, the system of the present invention incorporates a module that helps users articulate and achieve their performance improvement goals. Two types of organizations use the Accountability Module: a parent/sponsoring organization and a participating entity.

### BRIEF DESCRIPTION OF THE DRAWINGS

References are made to the accompanying drawings, which form a part of the description and in which are shown, by way of illustration, specific embodiments of the present invention:

FIG. 1 shows the relationship between a Sponsoring Organization, a Participating Entity, and a program participant;

FIG. 2 is an overview process taken by a Sponsoring Organization in accordance with one embodiment;

FIG. 3 is a flow diagram of a process performed by the Sponsoring Organization of creating a survey in accordance with one embodiment;

FIG. 4 describes steps taken by the Participating Entity in accordance with one embodiment;

FIG. 5 is an example of a simple graphic representation that is part of a Conceptual Framework in accordance with one embodiment;

FIG. 6 is a block diagram showing various components and modules of a Sponsoring Organization and a Participating Entity in accordance with one embodiment; and

FIG. 7 is a block diagram of a data processing system 500 in accordance with one embodiment.

FIG. 8 is a high-level flow chart of the survey accelerator system.

FIG. 9 is a flow chart of the Accountability Module.

FIG. 10 shows the database configuration of the Accountability Module.

### DETAILED DESCRIPTION OF THE INVENTION

Example embodiments of processes of creating surveys and analyzing large volumes of survey data are described. These examples and embodiments are provided solely to add context and aid in the understanding of the invention. Thus, it will be apparent to one skilled in the art that the present invention may be practiced without some or all of the specific details described herein. In other instances, well-known concepts have not been described in detail in order to avoid unnecessarily obscuring the present invention. Other applications and examples are possible, such that the following examples, illustrations, and contexts should not be taken as definitive or limiting either in scope or setting. Although these embodiments are described in sufficient detail to enable one skilled in the art to practice the invention, these examples, illustrations, and contexts are not limiting, and other embodiments may be used and changes may be made without departing from the spirit and scope of the invention.

In one embodiment, the system of the present invention incorporates a module that helps users articulate and achieve their performance improvement goals. Two types of organizations use the Accountability Module: a parent/sponsoring organization and a participating entity.

The described embodiment of the present invention involves the effective coordination of four entities: a Sponsoring Organization (“SO”), a Participating Entity (“PE”), program participants (“PP”), and a third-party service provider (“SP”). Many of the functions of the present invention which comprise the inventive steps are performed by the SO, may be facilitated in large part by the SP. However, this invention has, at its center, Big Data analytics, large volumes of data from multiple participants answering similar surveys at multiple PEs. The surveys are created by the SO (with guidance from the SP; herein it is understood that functions, steps, etc. taken by SOs may be facilitated or performed by the SP).

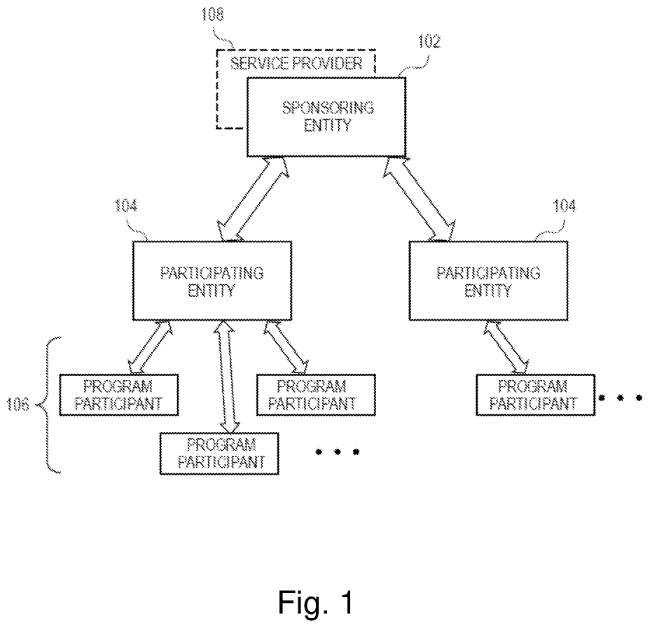

An SO is, in general, an organization that manages, coordinates, or provides services to other organizations, which other organizations are direct providers of Well-Being Programs. A very large urban school district (with hundreds of schools) might be the SO, the schools the PEs and the students the PPs, wherein Well-Being Program is after school childcare. More likely, a consortium of school districts in a state, or a national non-profit supporting school districts, might be the SO and the districts the PEs. The SO might be YMCA of the USA, and the PEs are the local YMCAs, PPs being YMCA members or parents of youth in Y programs. The SO might be a large, multi-facility integrated regional health care provider, and the PEs are local or neighborhood clinics, PPs are patients or members, and so on. FIG. 1 shows the SO, PE, PP relationship. A SO 102 may be a company, trade association, franchisor, or non-profit with affiliated PEs, steps taken by the SO may be facilitated by the Service Provider 108. The PE 104 is, in general, an organization that provides Well-Being Programs to members, clients, or customers. PEs subscribe to the survey and associated accountability and reporting tools. The SO 102 has a compelling interest in having each PE 104 offering programs that ultimately benefit PPs 106. In one embodiment, this invention applies to programs that have some explicit, social science-based intention. That is, the program is grounded in some theory of how it is that the physical or mental well-being of the PP, might be improved through engagement with the program. (An after school childcare program designed strictly to provide a safe place for elementary school age children until parents pick them up, would not be a candidate for this kind of evaluation, as the program has no intentional developmental content or purpose.)

Before describing embodiments of the present invention, it is helpful to give a few examples of how the invention, referred to as a “survey accelerator” for ease of explanation, is used and its objectives. In the described embodiment, the survey accelerator is used to measure the impact of Well-Being Programs as defined above. These include health enhancement programs or corporate engagement programs, non-clinical interventions for healthy living, medication compliance, improved chronic disease management, and the like. First, a generic description is provided. The PE offers a Well-Being Program to individuals, families, employees, etc., at a specific facility or location (e.g., a fitness center, school, community center, health clinic, corporate wellness center, and the like). A PE (say a school district) might declare that the goal of it's after school childcare program is to develop the Social and Emotional Learning (SEL) Competencies of its children. (In this example the SO might be the Collaborative for Academic Social and Emotional Learning (CASEL). Across the country in a given year there may be hundreds or thousands Participating Entities offering a similar after school SEL-oriented program. Well-Being Programs that share a common target audience and a common goal are referred to as “Like Programs.” The PE encourages PPs to take a survey of the impact and effectiveness of the program (those who take the survey and return their results are referred to as “responders” herein). A threshold requirement is that PPs taking the SO's survey have been exposed to a Like Program. PPs who share certain broad demographic characteristics (such as being an elementary school age child for an after-school program or a borderline-obese adult in a diabetes prevention program) are referred to as “Like Responders.” The survey they take is one created by the survey accelerator of the present invention, having questions specifically crafted to enable the PE to improve the well-being performance of its program.

The PE provides contact information on its PPs to the SO, and the SO (or the SO's SP) administers the survey for the PE. The same or nearly identical survey is given at all the PEs in the purview of an SO. The SO now has a large volume of survey data on a specific program for analysis and reporting. As noted, one of the objectives of the present invention is to use these data to improve the program: examine the data, make recommendations to PEs regarding the program, give the survey again, adjust the program based on reports and recommendations, and repeat. The survey accelerator provides for a feedback loop that outputs social science-based evidence for improving the experience and impact of such Well-Being Programs on its participants.

One feature of the present invention is a Conceptual Framework (CF). In the CF, the SO articulates a theoretical model, or a theory of the case, that the SO wishes to operationalize and measure. The CF is posted to the survey accelerator by the SO. In the described embodiment, the CF includes a brief verbal exposition of the social theory (or theories) along with a simple set of graphics to represent the underlying structure of the theory. Most social theory related to well-being is framed in terms of hypothetical constructs, such as Self-efficacy or Grit or Social Capital, which cannot be directly observed or measured. These constructs are said to be hidden or “latent.” Therefore, constructs in the CF are “operationalized” (i.e., rendered measurable) through a “Latent Variable Model.” Many latent variable models have multiple components which are called “dimensions;” such latent variable models are known as Multivariate Multi-Dimensional Latent Variable Models.

To render the latent variable model measurable, the SO (or more likely the SO's SP) must identify Questionnaire Items (QIs), each one of such items capturing some measurable aspect of a dimension of the latent variable model. The SO then specifies a set of mathematical procedures or operations to combine individual measures into an index or score for the dimension.

The described embodiment employs a relatively simple, statistically robust and easily explainable methodology for index creation called Multivariate z-Normalized Indexing. This methodology, which is feasible, in part, because of the dichotomization of response variables described below, has the attractive benefit of producing PE performance scores that can be interpreted as Percentile Rankings. The SO may also design its own custom survey questions and scales, or may refer to, for example, the social science literature which provides the SO with tested survey items and rating scales that may be adopted, or adapted as QIs for the SO's surveys. The SO packages the QI's into a survey to be administered to PPs in order to rate the impact and effectiveness of the PE's Well-Being Program or other types of programs.

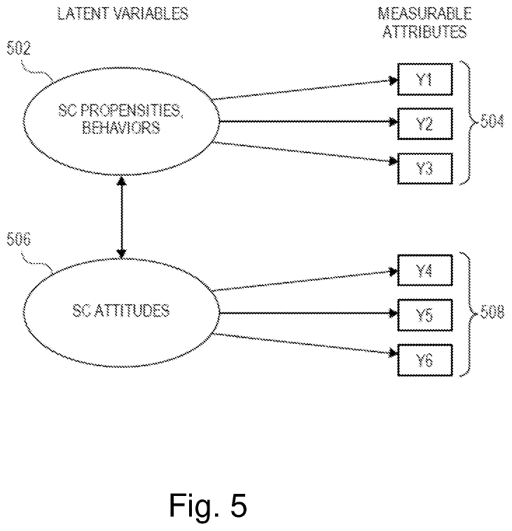

An example will be helpful. FIG. 5, below, is drawn from the 2011 University of Central Florida Doctoral Dissertation of Jim Downing. Downing was interested in the factors influencing the formation of social capital among members of the YMCA.

FIG. 5 is an example of a simple graphic representation that is part of the Conceptual Framework. The hypothetical construct of interest in this example is Social Capital (SC). SC is portrayed as having 2 dimensions: SC Propensities and Behaviors 502—those things that one might do; and SC Attitudes 506—those things that one might perceive or believe. The “measurables,” Y1, Y2, and Y3, are attributes regarding Propensities and Behaviors 504, each of which might be captured through one or more QI and denominated in a survey. For example, Y1 might be the behavior of voting, Y2 the behavior of attending community events, and Y3 the behavior of being a YMCA volunteer. Each of these measurable behaviors could be cast as a QI, (e.g., for Y1, “Did you vote in the last election?”). Measurables with respect to SC Attitudes 508 might be Y4 about the attitude of feeling connected to one's community, Y5 about a sense of belonging and Y6 about trust, all of which could also be cast as QIs (e.g., for Y4, “Since, joining the YMCA do you feel more connected to your community?”), etc.

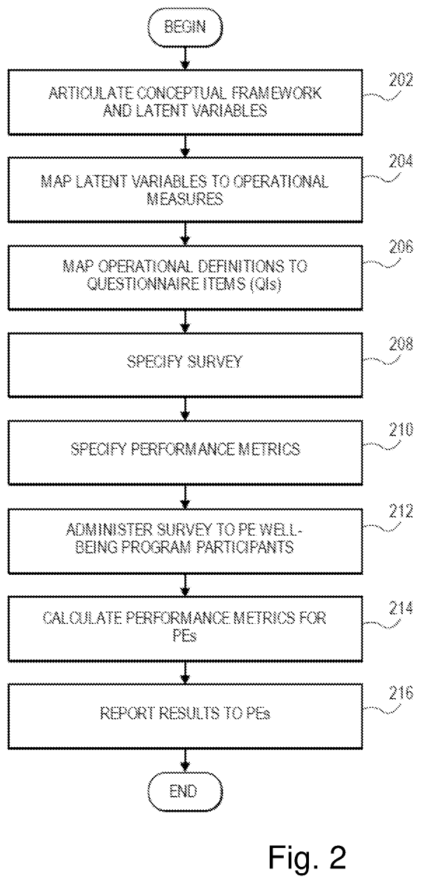

Now that various entities, scenarios, and examples have been illustrated, embodiments showing steps and analyses taken by the entities are described. As noted, the overall process is a feedback loop: create survey, administer survey, collect large survey data set, analyze data, provide recommendation, adjust program, use program, and repeat. FIG. 2 is an overview process taken by a SO in accordance with one embodiment.

At step 202 the SO creates a conceptual framework including a brief verbal statement of the theory (generally in bullet point form with references to the relevant literature for interested PEs) along with a graphic representation of the Latent Variable model. At step 204, the SO maps the latent variables to operational measures. Based on that, the SO develops a questionnaire for the survey.

At step 206, operational measures are mapped to Questionnaire Items (QIs) for inclusion in a survey instrument or questionnaire. At step 208, the survey instrument including question order, scales, respondent instructions, etc. is created by the SO. At step 210, the SO specifies performance metrics to be calculated and reported. At step 212, the survey is administered to the PPs of the PEs. Performance data are collected at the level of the PE and are aggregated across PEs for comparative purposes. While the data are collected from individual PPs responding to the survey, the unit of analysis and reporting is the performance of a specific Well-Being Program offered by a PE. For example, a corporation might offer both a healthy eating and a smoking cessation program. Data from multiple healthy eating programs would be aggregated as would data from multiple smoking cessation programs, but data from the two programs would not be combined. Only data from Like Responders in Like Programs are aggregated for analysis and reporting. At step 214 the SO, generally on an annual basis, distills findings from the data of all of the SO's PEs to calculate SO-wide averages and other norms. These provide comparative metrics and benchmarks. Such SO-wide benchmarks and norms, along with a PE's own historical data, serve as the analytical basis for calculating performance metrics for individual PEs. At step 216, the SO provides the PEs with reports and recommendations.

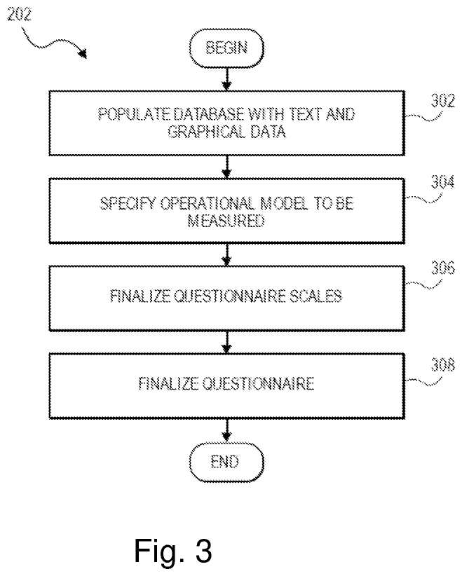

FIG. 3 is a flow diagram of a process performed by the SO of creating a survey. At step 302, the SO populates the database with a summary description and associated illustrations of the Conceptual Framework described above. These text and graphics data are stored in a database. At step 304, the SO specifies the operational model to be measured. The operational model maps the abstract constructs of the Conceptual Framework into measures to be used in the survey.

At step 306, specific questions and scales are finalized. At step 308, the SO completes the survey instrument by finalizing question text, response scales, question order, etc. to produce a ready-to-field questionnaire.

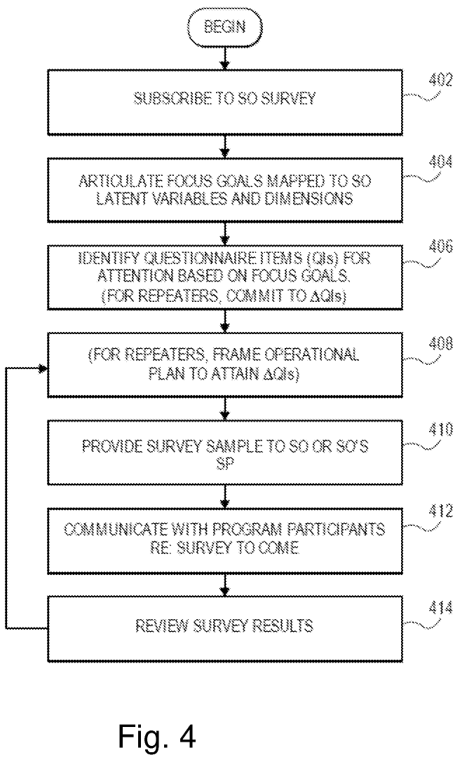

FIG. 4 describes steps taken by the PE in accordance with one embodiment. At step 402 the entity subscribes to the SO for the survey. In other scenarios, the entity may be required to give the survey.

At step 404, the PE articulates its specific goals with respect to the SO's Conceptual Framework. For example, CASEL has a 5-Dimensional SEL model. A specific school district PE might determine that the third grade SEL curriculum would focus on the “Self-awareness” dimension and within that dimension the goal would be to help increase students' self-efficacy beliefs. The social science literature indicates that overcoming a difficult obstacle or challenge is an excellent way to bolster a young person's sense of self-efficacy. So, this district will develop specific learning opportunities around overcoming challenges.

At step 406, the PE identifies specific QIs on the SO's questionnaire that it will target. Following the example above, the QIs selected for special focus may be, “I feel that my child has overcome a significant challenge this year.” And “my child's self-confidence has improved this year.” These two QIs will be the subject of intentional effort for all the 3^{rd} grade teachers in all the district's schools.

At step 408, the PE publishes its plan to increase performance on the self-efficacy and self-confidence QIs. This might include a section on how 3^{rd} grade teachers would work with parents to identify appropriate and impactful individualized challenges for each student in the class. At this step PEs who have historic reports from the SO on their performance would also commit to improvement targets for specific QI scores.

At step 410 the PE provides current contact information about PPs to the SO (or the SP) to enable delivery of surveys. At step 412, the PE uses communications and marketing techniques to inform PPs that a survey is coming and encouraging PPs to respond.

At step 414, the PE receives its survey report and conducts internal meetings to identify bright spots and areas of opportunity to address in the subsequent cycle. Staying with our example, the PE's PTA and staff might design a special program to celebrate improved survey results and to enhance parental buy-in on the SEL curriculum.

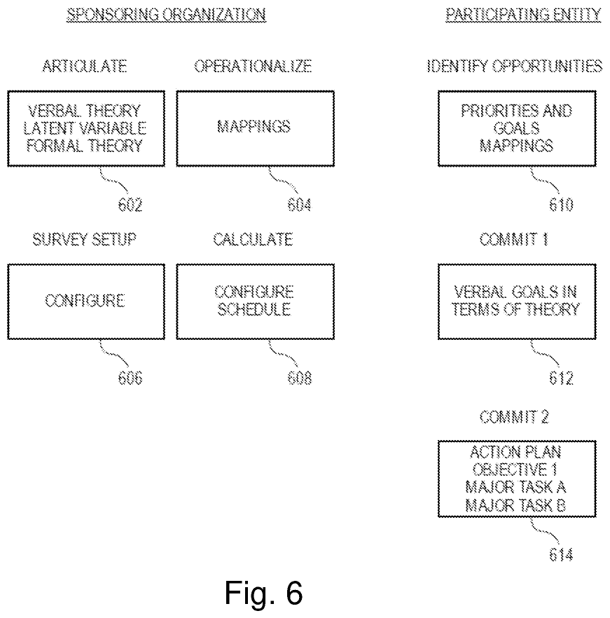

The present invention provides SOs with a suite of applications, software tools, databases, on-line reference material, APIs, and UIs, to support the SO in framing and publishing the CF, mapping the latent variables dimensions to measures, developing Qis, configuring the survey instruments and calculating metrics and reports. Referring now to FIG. 6, an “Articulate” module 602, provides a logical data capture framework along with simple graphic tools and access to reference materials. The tools and functionality support the SO in articulating the CF, drawing the graphic representation of the theory and related latent variables in step 202. An “Operationalize” module 604 provides look-up and mapping tools to connect operational measures to the latent variables in step 204. A “Survey Setup” module 606 provides configuration tools to capture and encode the final questionnaire survey instrument in step 308. A “Calculate” module 608 allows the SO to configure the inputs, operations, and output calculations. Module 608 also enables the SO to schedule calculation runs and to define comparative norms such as National Average, Standard Deviation, Top Quartile, Previous Year, and the like in step 214.

The present invention also provides PEs with a suite of applications, software tools, databases, on-line reference material, APIs, and UIs, to support the PE in articulating focus areas for their Well-Being Programs, publishing operational goals and plans, reporting current and historic results, and tracking the specific QIs targeted for improvement.

Recognizing that different PEs have different priorities and goals, an Identify Opportunities module 610 provides a UI for the Participating Entity to enter those priorities and goals and to map them to the latent variables and dimensions in the SO's CF, step 404. The PE reviews previous studies by the SO of its programs to understand performance to date and to identify specific areas of focus and action. PEs using the survey accelerator for the first time can review the reporting UI to understand the attributes measured and the underlying theory embodied in the survey. In can also determine how to connect program goals with measurable performance standards.

A PE may also use a Commit module which provides two web forms. The first web form, “Commit 1” 612 is used to gather PE-specific program goals and desired outcomes that are associated with the theory or conceptual framework embodied in the survey by the SO. The web form allows the identified goals and outcomes to be mapped to specific survey items and to a set of “A metrics” that is, measures of improvement on the specified questions on the survey. Thus, the PE commits to a specific, quantified, set of goals that attach logically to a theory of change at step 406.

A second web form, “Commit 2” 614 is used by the PE who is repeating a survey to capture a simplified action plan that attaches short-form answers to the following questions: Why does moving this attribute score matter? What will be done to move it? Who will be accountable for the actions and results? When will the associated tasks be completed? Answers to these questions help create an action plan for the PE to improve the program in step 408.

A reporting UI in Identify Opportunities module 610 displays custom progress updates on the attributes selected for focus in the Commit components Reporting UI.

### Analytical Features

One threat to validity is known in the field of survey methodologies as Selection Bias. Selection Bias occurs when the decision to participate in the program, rather then what the program does, is a main (or the main) driver of perceptions and outcomes. Surveys frequently report the effect of a Well-Being Program by comparing the outcomes of matched sets of participants and non-participants. For example, a survey may show that employees who participate in a workplace nutrition program improve their dietary habits more than a demographically matched set of employees who did not participate. Surveys reporting that difference as causal (i.e., better eating due to the program) ignore Selection Bias. Program enrollees signaled their intention to eat better by the fact of their enrollment in the program. That is, they had already made an important decision, to attempt to eat better, before the first session convened. Those intentions and decisions which signal readiness and a behavioral pre-disposition to change are likely to be as or more impactful on future behavior than the instructional content of the program. Unfortunately, there is no way to allocate the effect measured in a survey due to the program content. The survey is measuring both the effect of the program and the effect of the self-selection and attributing all of the effect to the program. This is a particularly egregious example, but nearly all program impact evaluations are subject to Selection Bias.

Another threat to validity of program impact evaluations is known as Response Bias. When a survey is administered some people respond and others don't. Response rates to surveys (responders/total sampled) range from under 1% to about 35% depending on the survey methodology employed and the salience of the survey subject matter to the recipient. To deal with fact that somewhere between 65% and 99% of those survey opted not to respond—in effect that all survey findings are minority reports—survey research methodology makes a (generally unstated or tacit) assumption. The underlying assumption of essentially all social science survey research is that the distribution of attitudes, opinions, preferences, intentions, behaviors etc. among respondents and non-respondents are identical, nearly identical or can be demographically ‘weighted’ to be close to identical. Put differently, the core assumption is that the opinions of people who opted to respond to the survey, correspond fairly closely to the opinions of people who opted not to take the survey. In many situations this is a reasonable assumption and produces estimates that are valid. In the described embodiment of Well-Being Program surveys, this assumption is not only generally false it is grossly false. Program participants who were generally pleased with the program respond at a much higher rate than those who did not complete the program, who were indifferent to it, or actively found the program to be ineffective. Moreover, those responses tend to be overwhelmingly positive. It is known that 80-90% of some 3 million responders to YMCA Well-Being Program surveys conducted over the past 15 years rated their program as either Excellent or Good. To assume that 80-90% non-responders shared that opinion is absurd. Non-responders don't respond to surveys, they just leave the program. Response bias in program impact evaluations causes those evaluations systematically to overestimate the reported effect of the program being evaluated. This is well known in the field. Unfortunately, the size of the bias is very difficult to measure because non-responders don't respond to surveys.

The combination of Selection and Response bias render traditionally conducted Well-Being Program surveys essentially meaningless. There are many other instances where positive Selection Bias and/or positive Response Bias are threats to the validity of evaluations of social science-based research. The strategies discussed below for the described embodiment are broadly applicable to address threats to research validity by recasting the Units of Analysis from treatment versus no treatment to Treatment A vs. Treatment B.

The current invention does not attempt to denominate the effect of a program versus no program, a logical impossibility. Rather, the present invention deals with Selection Bias by comparing the performance of Well-Being Programs offering Like Programs to Like Participants. The analysis requires aggregating of the ratings data on identical measures (QIs) based on the “measurables,” like Y1, Y2, and Y3 (see FIG. 5) that are mapped to the dimensions of a latent variable model developed to operationalize the CF of the SO. To calculate comparative performance requires large, statistically robust data sets from across multiple PEs operating under the auspices of an umbrella SO. The survey data are combined and analyzed in accordance with certain logical, analytical and mathematical procedures, which procedures produce statistically meaningful metrics allowing the effectiveness and impact of Like Programs offered by different PEs to be compared, ranked and tracked over time.

As noted above, Well-Being Program participants who respond to evaluations surveys tend to provide very positive ratings. The present invention deals with this (very positive) Response Bias, recasting the raw responses to drill beneath the positive halo of generally happy responders. Assume that 2 PEs, A and B, operating under the same SO, offer diabetes prevention programs to borderline-obese adults (Like Programs to Like Participants). Let's assume further that 85% of respondents at both A and B rate his/her program either “Excellent” or “Good.” 35% of Program A responders rate it as Excellent and 50% as Good. At Program B, 60% rate it as Excellent and 25% as Good. While both programs earn high overall scores (85%=85%) the break down or distribution of those scores is quite different. The “Top Box” (i.e., the highest available rating) scores are not equal (35%=60%). Dichotomizing the responses into Top Box/not Top Box reveals the underlying structure in Response Biased data.

In addition to revealing what statisticians refer to as “structure” (or meaning) in Response Biased data, analytics and modeling of such data is greatly facilitated by re-casting multi-point item response scales as dichotomous: 0 or 1. The simple “Top Box/not Top Box” transform allows variables with different scales (e.g., “Strongly Agree, Somewhat Agree, Somewhat Disagree;” “Excellent, Good, Fair, Poor;” “Yes, No;” 1-10) to be treated as yes/no or binomial variables and to be combined into multivariate indexes that represent a hidden or latent dimension.

When responses are dichotomized as yes/no variables (e.g., “did the respondent at PE A rate the diabetes prevention programs for borderline-obese adults program as “Excellent?” Yes or No?), it is possible to combine responses into simple proportions or rates (e.g., what is the percentage of respondents at PE A rating the diabetes prevention programs for borderline-obese adults program as “Excellent?”). Such rates have very attractive statistical properties. They are intuitively comparable, recall (35% #60%). More importantly, the Binomial Distribution, which is the frequency distribution of rates, closely approximates the Standard Normal Distribution with a mean and a Standard Deviation. Having measures sharing the Standard Normal Distribution facilitates all kinds of analytics, indexing and comparisons. In the described embodiment, it allows the SO to use Multivariate z-Normalized Indexing to score and compare Multivariate Multi-Dimensional Latent Variable Models.

The embodiment of the invention detailed in this document speaks to the use of the current invention in the field of measurement of the performance of intentional Well-Being Programs or other such interventions. Such interventions might be designed to provide learning, guidance, experience, skills, expertise, know-how, psychological or physical capabilities, mindsets, predispositions, etc., that result in the participants' physical or psychological development, improved sense of social connectivity, purpose, meaning-in-life, community engagement, etc. This is a large field of endeavor and includes much of what is attempted in elementary and secondary education, out-of-school time activities for young people, youth sports, corporate training, staff development, executive development and more. In the field of health, the present invention might be applied in supporting clinical and subclinical interventions in pain management, diabetes prevention, chronic disease management, and medication compliance promotion. Indeed, any intervention with the intentional objective of helping the participant become stronger, more capable, competent, and in a word to feel better, is covered by the detailed description of the embodiments.

However, there are vast areas of social science research and human practice that have nothing to do with well-being promotion for which the current invention could be a valuable tool. In principle, any social science based investigation, test or measurement protocol in which questionnaires are used to measure respondent attitudes, beliefs, intentions, perceptions, etc. where such attitudes, beliefs, intentions, perceptions, etc. are mapped to dimensions of multivariate latent variable models could benefit from the current invention. In Political Science, researchers and practitioners (policy makers, politicians and bureaucrats) are interested in measuring such constructs as political mobilization, strength of party affiliation, and issue salience. Sociologists measure constructs like social capital, social class and community cohesion. Economists measure constructs like standard of living, relative deprivation, and human capital. And it's hard to think of examples from the field of Psychology that don't involve hypothetical constructs and latent variable models.

There are a handful of highly prestigious organizations in the US that conduct Big Social Science of the very highest quality. At the same time, academic researchers at hundreds of colleges and universities conduct idiosyncratic studies with one-off questionnaires on small samples of respondents. The invention described herein provides multiple users (academics and practitioners) with rigorous explicit mappings of theory to measure, to Questionnaire Item, to dimension etc. to generate massive volumes of data that can be analyzed with Big Data tools. The innovative organizational structure proposed herein with the Sponsoring Organization, connecting multiple Participating Entities into learning networks delivering commensurable measures and vast nation data sets might enable the Participating Entities to conduct social science at scale building fully commensurable metrics and cumulative learning in a remarkably cost-effective manner. The tools of this invention's implementation include software (data bases, APIs, UIs), and configuration tools, for questionnaire set-up, calculation set up and other features to facilitate the conduct of social science research among and across different types of Participating Entities. The implementation of such tools could foster collaboration across academics and practitioners to advance the art of social science in ways analogous to how the collaborative use of Big Science tools, like particle accelerators, have helped to advance physical science.

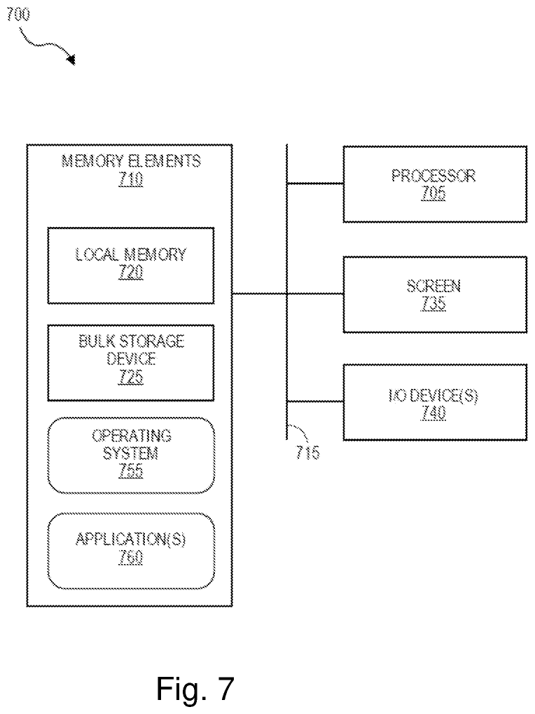

FIG. 7 is a block diagram of a data processing system 700 in accordance with one embodiment. System 700 may be used to implement any of a variety of systems and/or computing devices that include a processor and memory, and that are capable of performing the operations described within this disclosure. In one embodiment, it can be used to implement a smart watch or phone. It can also be used to execute computer instructions to implement the logic flowcharts in FIGS. 2 and 4. The device may be any device described in connection with FIGS. 1-4.

As pictured, system 700 includes at least one processor 705 coupled to memory elements 710 through a system bus 715 or other suitable circuitry such as an input/output (I/O) subsystem. System 700 stores program code within memory elements 710. Processor 705 executes the program code accessed from memory elements 710 via system bus 715. Memory elements 710 include one or more physical memory devices such as, for example, a local memory 720 and one or more bulk storage devices 725. Local memory 720 refers to random access memory (RAM) or other non-persistent memory device(s) generally used during actual execution of the program code. Bulk storage device 725 may be implemented as a hard disk drive (HDD), solid state drive (SSD), or other persistent data storage device. System 700 may also include one or more cache memories (not shown) that provide temporary storage of at least some program code, in order to reduce the number of times program code must be retrieved from bulk storage device 725 during execution.

System 700 may be coupled to one or more I/O devices such as a screen 735 and one or more additional I/O device(s) 740. The I/O devices described herein may be coupled to system 700 either directly or through intervening I/O controllers. In one aspect, screen 735 may be implemented as a display device that is not touch sensitive. In another aspect, screen 735 may be implemented as a display device that is touch sensitive.

Examples of I/O device(s) 740 may include, but are not limited to, a universal remote control device, a keyboard, a mobile device, a pointing device, a controller, a camera, a speaker, and a microphone. In some cases, one or more of the I/O device(s) may be combined as in the case where a touch sensitive display device (e.g., a touchscreen) is used as screen 735. In that case, screen 735 may also implement a keyboard and a pointing device. Other examples of I/O devices 740 may include sensors. Exemplary sensors may include, but are not limited to, an accelerometer, a light sensor, touch screen sensors, one or more biometric sensors, a gyroscope, a compass, or the like.

I/O devices 740 may also include one or more network adapter(s). A network adapter is a communication circuit configured to establish wired and/or wireless communication links with other devices. The communication links may be established over a network or as peer-to-peer communication links. Accordingly, network adapters enable system 700 to become coupled to other systems, computer systems, remote printers, and/or remote storage devices, such as remote servers storing content. Examples of network adapter(s) may include, but are not limited to, modems, cable modems, Ethernet cards, wireless transceivers, whether short and/or long range wireless transceivers (e.g., cellular transceivers, 802.11x (Wi-Fi™) compatible transceivers, Bluetooth® compatible transceivers, and the like).

As pictured in FIG. 7, memory elements 710 may store an operating system 755 and one or more application(s) 760, such as applications for translating symbols and zero-amplitude time durations and symbol mapping tables. It may also store software for segmenting or breaking a message (to be transmitted) into pieces or segments that can be represented by symbols. In one aspect, operating system 755 and application(s) 760, being implemented in the form of executable program code, are executed by system 700 and, more particularly, by processor 705. As such, operating system 755 and application(s) 760 may be considered an integrated part of system 700. Operating system 755, application(s) 760, and any data items used, generated, and/or operated upon by system 700, are functional data structures that impart functionality when employed as part of system 700.

As noted, in one aspect, system 700 may be used to implement a smart phone, smart watch, or other type of wearable device. In another aspect, system 700 may be used to implement a computer, such as a personal computer, a server, or the like. Other examples of mobile computing devices may include, but are not limited to, a tablet computer, a mobile media device, a game console, a mobile internet device (MID), a laptop computer, a mobile appliance device, or the like.

System 700 may include fewer components than shown or additional components not illustrated in FIG. 7, depending upon the particular type of device that is implemented. In addition, the particular operating system and/or application(s) included may also vary according to device type, as may the types of network adapter(s) included. Further, one or more of the illustrative components may be incorporated into, or otherwise form a portion of, another component. For example, a processor may include at least some memory.

### Functional Modules of the Platform

At a high level, the modules are Configuration, Data Processing, and System.

Environment

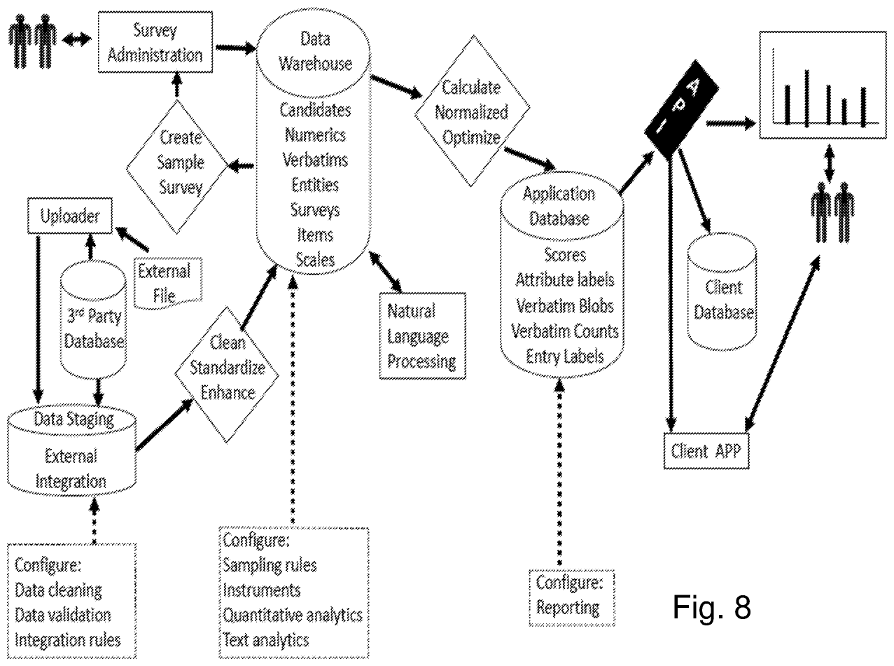

Configuration: (refer to dash-line boxes in FIG. 8)—Back-end Admin User Interface (UI).

Data:
a. Input data cleaning & standardization
b. 3rd party demographics
c. 3rd party transactions
d. Sampling rules

Instrument(s):
a. Items & scales
b. Item order
c. Batteries
d. Skip patterns
e. Open ends
f. Assign Form Codes

Analytics:
a. Base spec, per item for attribute calculations (survey/question)
b. Simple and complex attribute calculations
c. Segments
d. Index to latent variable mappings
e. Item to index mapping
f. NLP libraries
g. Tag-to-concept, concept-to-category/sub-category mappings

Accountability:—User-facing Web Form
a. Verbal statement of issue/opportunity/goal
b. Logic model/theory of action
c. Mapping of desired improvement to latent variables, indexes and attributes
d. Reference current and historic attributes and indexes for special attention
e. Quantitative goals

Reporting: Mobile-enabled web app
a. HTML pages for interactive UI
b. .xls exports
c. Printable reports
d. Accountability results

Data Processing (refer to diamond boxes in FIG. 8)

Ingest Data:—Staging
a. Apply standardization/cleaning processes
b. Stage 3rd party demographics and/or transactions

Administer Surveys:—3rd party tools
a. Create Candidate set
b. Populate data collection tools
c. Collect survey responses

Analyze Scaled Responses:—Data warehouse
a. Calculate simple (univariate) attributes
b. Calculate complex (multivariate) attributes
c. Calculate indexes

Analyze Open Ended Responses:—3rd Party Tools
a. Apply NLP algorithms
b. Map NLP tags to the ontology—Data warehouse

Post Processed Data:
a. “Persons,” “Transactions,” “Locations,” “Numeric,”—Data warehouse
b. “Candidates,” and “Verbatims,” to fact and dimension
c. Tables
d. Calculated attributes and indexes to import tables—Data warehouse
e. Calculated attributes and indexes to normalized tables—Import database
f. Normalized attributes and indexes to views in reporting—Reporting
database
g. Database and API
h. Entity-specific data for reporting—Application server and mobile-enabled UI

System:

External Data Staging and Integration Layer:
a. Store source input documents (e.g., raw customer files, raw order information, etc.)
b. Capture “Accountability” info from web form; populate Accountability tables in Reporting Layer
c. Post and validate order information
d. Map incoming header to target structure; store settings for subsequent use (Proprietary App)
e. Stripe all incoming records to reference source documents; allow all records associated with ‘bad input docs’ to be logically deleted
f. Any identified bad piece of data can be tracked back to the source and removed
g. Implement proprietary data cleansing, standardization, mapping
h. Connect with hosted client transactions and 3rd party geo and demo enhancements, and other available data sources as requested
i. Connect with service for survey implementation/data collection (3rd party software)
j. Post collected surveys to staging for QC
k. Post finalized data to data warehouse

Data Warehouse Layer:
a. Populated Candidate, Response, and Location fact tables
b. Run verbatim Natural Language Processing to assign tags (3rd party software)
c. Roll up tags using study-specific ontology (proprietary expert system)
d. Load and run Survey and Reporting configuration tables
e. Post categorized NLP tags to Verbatim fact table
f. Stripe facts in fact tables with UUIDS from Entity, Batch, Form Code, and other dimension tables
g. Run scripts and stored procedures to calculate attributes, norms, indexes, net scores, percentiles, etc. at the level of the entity/batch.
h. Stage calculations and run validations scripts and procedures
i. Capture “Accountability” input through web form, post

Import Database Layer:
a. Populated Entity, Location and Attribute Tables
b. Populated transaction roll-ups/transforms/calculations to attribute tables
c. Experian data overlay
d. Geospatial data append
e. Create inputs for Normalized tables in Reporting Layer

Reporting Layer:
a. Populated Normalized tables
b. Populate Accountability table
c. ETL into reporting views
d. API (Java Spring) available for third party connections
e. UI (HTML 5, Fusion Charts, D-3)
f. Report on Accountability

The accountability module:

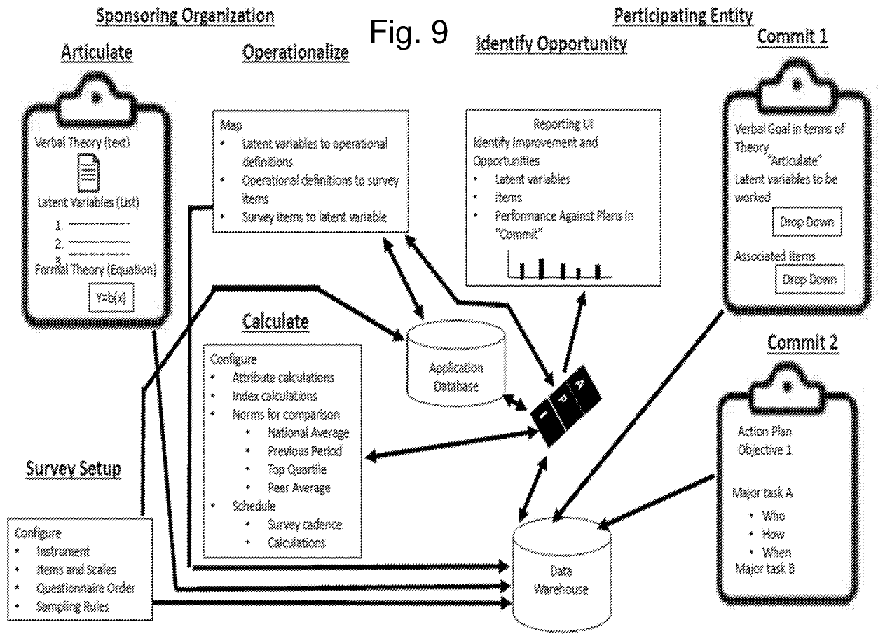

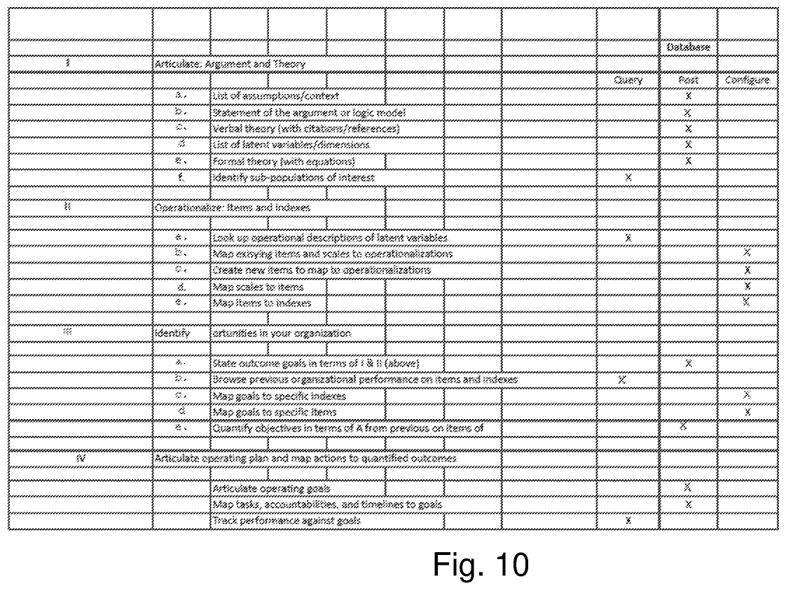

The parent/sponsoring organization manages the survey accelerator system through the Articulate, Operationalize, Survey Set-up and Calculate components shown in FIGS. 9 and 10. The participating entity subscribes to surveys and associated accountability and reporting tools offered by the parent/sponsoring organization.

The Articulate component exposes a web form in which the parent/sponsoring organization outlines its theory of the case and specifies the latent variables to be measured in the study.

The Operationalize component exposes a web app used to query a database for specifications, operational definitions, and mappings of the latent variables selected in the Articulate component. A configuration UI allows an administrator to create new items. The UI also allows scaling and mapping survey items to existing and new theory operationalizations and associated indexes.

The Commit component provides two web forms. The first web form, “Commit 1,” is used to gather participating entity-specific program goals and desired outcomes that are associated with the theory embodied in the survey. The web form allows the identified goals and outcomes to be mapped to specific survey items and to a set of “A metrics” on the specified survey items. Thus, the participating entity commits to a specific, quantified, set of goals that attach logically to a theory of change. The second web form, “Commit 2,” captures a simplified action plan that attaches short-form answers to the following questions: Why does moving this attribute score matter? What will be done to move it? Who will be accountable for the actions and results? When will the associated tasks be completed?

The reporting UI used in the Identify Opportunities component, displays custom progress updates on the attributes selected for focus in the Commit component Reporting UI.

Although illustrative embodiments and applications of this invention are shown and described herein, many variations and modifications are possible which remain within the concept, scope, and spirit of the invention, and these variations would become clear to those of ordinary skill in the art after perusal of this application. Accordingly, the embodiments described are to be considered as illustrative and not restrictive, and the invention is not to be limited to the details given herein but may be modified within the scope and equivalents of the appended claims.

What is claimed is:

1. A study using a survey and the survey creation and administration system comprising a survey accelerator system wherein the sponsoring organization manages said survey accelerator system wherein:
the sponsoring organization first inputs the statement of issue;
the sponsoring organization next inputs logic model into the accountability module;
the sponsoring organization then inputs the survey measurements and instruments into the said accountability module;
the participating entity commits to a specific, quantified, set of goals that attach logically to a theory of change;
the participating entity uses the theory of the case and survey measurement and instruments metrics and inputs the results of at least one participant;
the sponsoring organization then operates the survey accelerator system;
the accelerator module interfaces with a reporting tool and returns the simplified action plan.

2. The accountability module system of claim 1 comprising of an Articulate, Operationalize, Survey Set-up and Calculate components.

3. The Articulate component of claim 2 comprising of a web form that captures the theory of the case and specifies the latent variables to be measured.

4. The Operationalize component of claim 2 comprising of a web form that is used to query a database for specifications, operational definitions, and mappings of the latent variables selected in the Articulate component.

5. The Survey Setup component of claim 2 comprising of a User Interface to configure the survey instrument survey items, scales, item ordering, business rules, minimum cell sizes and survey formatting.

6. The Calculate components of claim 2 comprising of a data input web form that for the input arguments, operations and output calculations to be performed on the data collected in the survey.

7. The simplified action plan of claim 1 comprising of short-form answers to the following questions:
Why does moving this attribute score matter?
What will be done to move it?
Who will be accountable for the actions and results?
When will the associated tasks be completed?

8. The theory of the case of claim 1 wherein the sponsoring organization specifies the latent variables to be measured said study.

9. The theory of change of claim 1 wherein the participating entity identifies questionnaire items comprising of quantitative goals and opportunity identification module for providing a user interface to enable a Participating Entity to enter priorities and goals and mapping of said priorities and goals to latent variables and dimensions in said conceptual framework.

10. The accountability module of claim 1 wherein the accountability module reports:
the statement of issue/opportunity/goal;
the Logic model/theory of action;
the Mapping of desired improvement to latent variables, indexes and attributes;
the current and historic attributes and indexes for special attention;
the Quantitative goals.

11. The survey measurements of claim 1 wherein the survey measurements comprise of measuring perceptions of participating entity customers.

12. The survey instruments of claim 1 wherein the survey instruments comprise of survey questionnaires.

13. The statement of issue of claim 1 wherein the statement of issue is a list of opportunities and goals that the goal Participating Entity solicits answers from the clients.
